(19) United States
(12) Patent Application Publication
(10) Pub. No.: US 2016/0309552 A1
(43) Pub. Date: Oct. 20, 2016

(54) CONTROLLING A LUMINOUS MEANS HAVING AT LEAST TWO SEMICONDUCTOR LIGHT SOURCES

(71) Applicant: OSRAM GmbH, München (DE)

(72) Inventors: Ronny Kuerschner, Laaber (DE); Jens Richter, Painten (DE)

(21) Appl. No.: 15/038,057

(22) PCT Filed: Nov. 6, 2014
(86) PCT No.: PCT/EP2014/073962

§ 371 Date: May 20, 2016

(30) Foreign Application Priority Data
Nov. 20, 2013 (DE) 10 2013 223 710.3

(51) Int. Cl. H05B 33/08; H05B 37/02

(52) U.S. Cl. CPC H05B 33/0815; H05B 33/0845; H05B 37/0281

(57) ABSTRACT

Various embodiments relate to a control device for a luminous means which has at least two semiconductor light sources, can be connected to an electrical energy source and is intended to use the semiconductor light sources to convert an electrical power provided by the electrical energy source into an emitted light power dependent on the electrical power provided. The semiconductor light sources are connected to the control device and the control device adjust the electrical power provided by virtue of the control device having a clock generator which is designed to apply electrical power to the semiconductor light sources during clocked operation. The clock generator controls the semiconductor light sources according to clock pulse sequences individually associated with the semiconductor light sources in such a manner that clock pulses in a first clock pulse sequence have a time shift with respect to clock pulses in a second clock pulse sequence.

### RELATED APPLICATIONS

The present application is a national stage entry according to 35 U.S.C. §371 of PCT application No.: PCT/EP2014/073962 filed on Nov. 6, 2014, which claims priority from German application Nos.: 10 2013 223 710.3 filed on Nov. 20, 2013, and is incorporated herein by reference in its entirety.

### TECHNICAL FIELD

Various embodiments relate to a control device for a luminous means having at least two semiconductor light sources and which can be connected to an electrical energy source for conversion of an electrical power provided by the electrical energy source by means of the semiconductor light sources into an emitted luminous power dependent upon the electrical power provided, wherein the semiconductor light sources are connected to the control device and the control device is adapted to adjust the electrical power provided, whereby the control device has a clock generator, which is configured to apply electrical power to the semiconductor light sources in a clocked mode. Various embodiments further relate to a lighting device having a luminous means including a plurality of semiconductor light sources, an electrical connection for connecting the lighting device to an electrical energy source, as well as a control device, to which the semiconductor light sources are connected. Various embodiments further relate to method for controlling a luminous means having at least two semiconductor light sources and connected to an electrical energy source, wherein the luminous means converts an electrical power provided by the electrical energy source by means of the semiconductor light sources into an emitted luminous power dependent upon the electrical power provided, the provided electrical power is adjusted by means of a control device, whereby the electrical power is applied to the semiconductor light sources by means of the control device in a clocked mode, wherein the semiconductor light sources are controlled according to clock pulse sequences individually associated with the semiconductor light sources. Finally various embodiments relate to a computer program product.

### BACKGROUND

Luminous means of the generic type as well as control devices for these and methods for controlling these are basically comprehensively known in the prior art so that a separate documentary evidence is not required for this. Generic luminous means are used, inter alia, for illuminating purposes, for example, for lighting rooms, working areas, or the like. Furthermore, such luminous means are also increasingly used in vehicles, for example, as headlamps or the like. The generic luminous means includes a multiplicity of semiconductor light sources, which are actuated accordingly by means of the control device in order to achieve a desired illumination effect. For this purpose, the semiconductor light sources are connected to the control device. From the control device the semiconductor light sources are at the same time also supplied with electrical energy, so that the semiconductor light sources generate light according to the electrical energy supplied to them. The generated luminous power is in this case inter alia dependent upon the electrical power supplied to the semiconductor light source.

In order to be able to adjust the power in the desired manner, it is known to vary an electrical voltage for the respective semiconductor light source. However, this method of power control has some disadvantages, for example, a high technical expenditure on the part of the control device, in order to be able to adjust the desired voltage, and strong batch-dependent brightness fluctuations of individual semiconductor light sources among one another, and/or the like, so that this method for power control of semiconductor light sources has substantially not proved successful.

For this reason, it is common practice to apply electrical power in a clocked mode to the semiconductor light sources for the purpose of power adjustment so that the semiconductor light sources can be operated in a switched-on state in each case at a predefined, optimal operating point. For this purpose, the semiconductor light sources are exposed to clock pulse sequences, wherein the clock pulse sequences are each associated with a corresponding average emitted luminous power. One method for adjusting the power is based, for example, on pulse width modulation (PWM), wherein a corresponding clock ratio is adjusted according to the desired power to be set. A clock rate of the clock pulse sequence is in this case selected in such a manner that the intended lighting function is not substantially adversely effected by this.

The aforesaid clocked mode can, however, result in energy supply problems with regard to circuit feedbacks, electromagnetic compatibility, or the like.

### SUMMARY

The luminous means converts the electrical power provided by the electrical energy source by means of its semiconductor light sources into an emitted luminous power dependent upon the provided electrical power. For this purpose, the luminous means is connected to the electrical energy source, for example, whereby the luminous means has suitable electrical connections for this purpose, via which a corresponding connection to the electrical energy source can be made. The electrical energy source can, for example, be a public energy supply network, a regenerative energy generating system, for example, a solar plant, a wind power plant, but also a fuel cell, an internal combustion engine-generator set, combinations thereof or the like.

Luminous means of the generic type frequently have a plurality of semiconductor light sources, which are connected to the control device. For this purpose, corresponding wirings can be provided, for example, a series circuit at least of parts of the semiconductor light sources, a parallel circuit, combinations thereof, in particular matrix circuits, and/or the like.

In particular, when using generic luminous means in the area of vehicle headlamps or front headlamps in vehicles such as automobiles, there is a plurality of advantages such as, for example, the implementation of a bending light without the need for a mechanism, the implementation of safety-relevant functions and/or the like. Safety-relevant functions may, for example, include the fading out of an oncoming vehicle in order to reduce a dazzle effect or the emphasis of dangerous spots and/or situations by increasing the brightness in such an area. Furthermore, the energy efficiency can also benefit from the use of generic luminous means, in particular when only the partial area of the luminous means which is required for the desired generation of a light distribution is actuated or activated, in contrast to solutions in which a desired light distribution is produced by trimming by means of apertures in a classical luminous means.

Various embodiments provide a control device, a method, as well as a lighting device and a computer program, by which means an improvement can be achieved in this respect.

Various embodiments are concerned in particular with the effects of the use of semiconductor light sources on the electrical energy supply and the electromagnetic compatibility. Semiconductor light sources are light sources, which consist of a solid, which, as a result of its physical properties, produces light when exposed to an electric current. The use of semiconductor light sources of this type requires particular measures in order to be able to produce the light in the desired manner and at the same time be able to achieve a reliable operation as intended. At the same time, semiconductor light sources usually have very small time constants, which explains why a variation of the supplied electrical power frequently substantially directly results in a corresponding variation of the luminous power emitted by the semiconductor light source.

Through the provision of clock pulse sequences according to various embodiments, the effects of the operation of semiconductor light sources as intended on the electrical energy supply can be reduced significantly. Frequently, one luminous means includes a multiplicity of semiconductor light sources. The semiconductor light sources can be wired in an electrical series circuit, in an electrical parallel circuit, in mixed forms thereof, in particular matrix circuits and/or the like. The maximum luminous power of the luminous means formed by them is determined by the number of light sources. In particular, it can be achieved by the wiring that a lower number of semiconductor light sources of the luminous means can each be actuated jointly by means of a clock pulse sequence.

The semiconductor light sources are connected to the electrical control device and are exposed to electrical energy from this in order to be able to execute their intended light-generating function in the intended manner. For this purpose, the semiconductor light sources can be connected individually or also in groups to the control device. In the case of a group-wise connection to the control device, the semiconductor light sources of the group can only be operated jointly by means of a clock pulse sequence.

The electrical energy source provides the power which is required for the intended operation of the luminous means, which is preferably the provided electrical power. The provided power accordingly in particular includes the electrical power which is obtained through the application of electrical power to the semiconductor light sources by the control device. In addition, an electrical lead of the control device as well as further required components can also be included. The provided electrical power of the electrical energy source is preferably the electrical power delivered in a substantially stationary operating state of the luminous means and/or the control device to said luminous means or said control device.

The control device has electronic switching elements for the semiconductor light sources or groups of semiconductor light sources connected to it, which apply an electrical power or an electrical current to the semiconductor light sources as intended. The electronic switching elements are usually configured as semiconductor switches. However, they can also be configured as nanoswitching elements, combinations thereof, or the like. The switching elements can also be provided as a separate assembly or else they can be formed in one piece with the control device. For example, the switching elements can be provided as an electronic circuit, semiconductor chip, combinations thereof, or the like.

Semiconductor switches in the sense of this disclosure are preferably controllable electronic switching elements, for example a transistor, in particular a bipolar transistor, a thyristor, combination circuits thereof, for example a metal oxide semiconductor field effect transistor (MOSFET), an isolated gate bipolar transistor (IGBT), or the like.

The switching mode of the semiconductor switch means that in a switched-on state, a very low electrical resistance is provided between the connections of the semiconductor switch forming the switching path, so that a high current flow with very low residual voltage is possible. In the switched-off state the switching path of the semiconductor switch is high-resistance, that is, it provides a high electrical resistance so that even when a high voltage is applied to the switching path, substantially no current flow or only a very low, in particular negligible, current flow exists. A linear mode which, however, is not used in electronic switching elements, differs from this.

Preferably, the number of switching elements switched on by means of the control device determines the power provided by the electrical energy source. It can furthermore be provided that the control device controls the electrical energy source in relation to the power provision. A control can also be provided for a clocked electronic energy converter, by means of which the electrical power provided by the electrical energy source is converted into an electrical power suitable for the control device.

Naturally it can also be provided that all the semiconductor light sources are each singly and individually connected to the control device. In this way, each semiconductor light source can be individually actuated in the desired manner by the control device. In particular, it can also be provided here that groups of semiconductor light sources are formed which are controlled with a common clock pulse sequence by the control device. This has the advantage that the group formation can be specified by the control device itself and optionally, if required, can be adapted whereby individual ones or a plurality of semiconductor light sources can be added to the group or removed from the group.

Even though various embodiments are further explained subsequently by reference to vehicle headlamps as lighting device, the explanations are not, however, restricted to vehicle headlamps and can naturally also be used in any other lighting devices or luminous means.

With various embodiments, it is possible to achieve a dynamically varying light distribution of the luminous means, which can be achieved by a corresponding actuation of the semiconductor light sources of the luminous means. With the varying light distribution of the luminous means, the distribution of the electrical power over the luminous means also varies, that is, the local power density, and specifically over the semiconductor light sources comprised by the luminous means.

In the case of a vehicle headlamp, for example, a time-averaged current requirement of approximately 13 to 16 A can be adjusted with a typical light distribution, wherein such a vehicle headlamp can, for example, require an electrical current in a range of 33 to 38 for maximum light production. The difference between the two aforesaid values of the electrical current is seen as a margin, which for example can be held in readiness for the illumination when traveling round bends. It is thereby possible to expediently also illuminate a pivot region with such a vehicle headlamp when traveling round bends and thus improve the overall driving safety.

From this it follows that naturally the current distribution or the power distribution varies dynamically over the semiconductor light sources forming the luminous means depending on a driving situation.

Semiconductor light sources have the property that their light generation is substantially directly dependent on the supplied electrical power or the supplied electrical current. Accordingly, time constants for variation of an illumination state of the luminous means are very small. A luminous means of the generic type for a vehicle headlamp may, for example, have 3,000 or more semiconductor light sources, which can be actuated by the control device, preferably individually by means of a preferably individual clock pulse sequence in the form of a pulse width modulation (PWM). The energy supply of the individual semiconductor light sources is accomplished in parallel by the electrical energy source to which the luminous means is connected.

As a result of the plurality of semiconductor light sources and the required dynamics and efficiency of the system thereby formed, particular requirements are obtained for an electrical circuit of the control device, by means of which the required or desired operating states of the luminous means can be implemented. It is therefore an important aspect of various embodiments to bring about an improvement here so that requirements on the electronic circuit can be reduced significantly without restricting the possibilities of the luminous means, for example, in an application as a vehicle headlamp. Even if this inventive aspect is particularly defined with a large number of semiconductor light sources, the advantageous effects can naturally also be demonstrated even with a small number of semiconductor light sources—for example, two or more.

For this purpose, the control device may, for example, include a controllable, electronic clocked energy converter, for example, a step-down converter, a step-up converter, or the like, which is preferably part of the electronic circuit. The electronic clocked energy converter preferably obtains the electrical power directly from the electrical energy source.

Furthermore, it should be noted that the complexity of the actuation of such a vehicle headlamp as well as also corresponding luminous means in general, and the associated signal processing power to be held available, requires new approaches, which in particular enable the clocked electronic energy converter to be prospectively regulated.

One aspect of various embodiments is the time shift of the clock pulse sequences for the individual semiconductor light sources with respect to one another with the aim of being able to reduce load jumps or power jumps, in particular at the beginning of a respective clock cycle. However, various embodiments should not be seen as only restricted to this but generally serves to also detect operating states of the generation of luminous power by means of the luminous means, and specifically in particular transitions from one light-generating state to another light-generating state. The latter can be achieved, for example, according to various embodiments whereby the clock pulse sequences for the semiconductor light sources are combined into pulse patterns for a specific illumination state of the luminous means and on transition from one light-generating state to another light-generating state of the luminous means, pulse patterns are interposed, which mitigate an abrupt change of the supplied electrical power.

With invention various embodiments, it can be achieved that requirements for the electronic clocked energy converter can be significantly reduced. In particular, requirements for power electronics of a step-down converter can be reduced.

Furthermore, the dynamics of the power consumption of the luminous means or the current consumption of the luminous means can be reduced by an interpolation of state transitions by means of interposed pulse patterns or an adaptation of load jumps or power jumps to the actually required dynamics during, for example, a negotiation of bends. Furthermore, as a result of the shift of PWM cycles or clock pulse sequences of the individual semiconductor light sources with respect to one another, a reduction of the maximum total current to be provided or the maximum total power to be provided over the entire semiconductor light source structure of the luminous means can be achieved.

It proves to be particularly advantageous if both aforesaid aspects are combined, with the result that the requirements for the electrical energy source or the electronic clocked energy converter can be reduced significantly. On the one hand, it can be avoided that the electronic clocked energy converter must map the complete dynamics of the luminous means and the power reserve to be held in readiness must be designed accordingly. As a result, the expenditure relating to the electronic clocked energy converter can be reduced, with the result that lower costs are obtained. Furthermore, feedback effects on the electrical energy source, in particular on an energy supply network, can be reduced. This proves to be particularly advantageous for island networks, for example, an onboard network of a vehicle or the like. For example, the expenditure for a filtering can be reduced.

Various embodiments furthermore propose that the control device includes an electronic clocked energy converter controllable by means of the control device. As a result of the possibility of controlling the electronic clocked energy converter by means of the control device, it can be achieved that this is adaptively, in particular proactively, controlled so that it is possible to respond better to state changes, in particular changes of light-generating states, of the luminous means. By this means, expenditure in the area of the electronic clocked energy converter, for example, in the area of filtering and/or the like, can be reduced.

The semiconductor light source may preferably include a light-emitting diode or a laser diode. Such light-emitting diodes or laser diodes can also be combined with one another in a modular manner. In particular, they can be formed on a common chip or the like. Light-emitting diodes or laser diodes or combinations thereof are particularly suitable for use as a semiconductor light source in various embodiments.

On the lighting device side, it is consequently in particular proposed by various embodiments that the lighting device has a luminous means including a plurality of semiconductor light sources, an electrical connection for connecting the lighting device to an electrical energy source as well as a control device, to which the semiconductor light sources are connected. The control device is configured according to various embodiments. The lighting device can, for example, be formed by a vehicle headlamp, a vehicle rear light but also by a lamp for a room light or the like. The lighting device itself can, for example, be configured for this purpose to detachably receive and electrically contact the luminous means. For example, the luminous means can be configured as a replaceable unit or a replaceable module. In particular, the luminous means can have a connecting socket, by means of which it can be connected to the lighting device at the same time both mechanically and electrically. In this way, it is possible to replace a defective luminous means of the lighting device with an intact luminous means. In addition, this configuration enables various embodiments also to be retrofitted to existing lighting devices.

On the control device side, it is therefore proposed in particular with various embodiments that the control device is suitable for a luminous means having at least two semiconductor light sources and which can be connected to an electrical energy source for conversion of an electrical power provided by the electrical energy source by means of the semiconductor light sources into an emitted luminous power dependent upon the electrical power provided, wherein the semiconductor light sources are connected to the control device and the control device is adapted to adjust the electrical power provided, whereby the control device has a clock generator, which is configured to apply electrical power to the semiconductor light sources in a clocked mode, wherein the clock generator is adapted to control the semiconductor light sources according to clock pulse sequences individually associated with the semiconductor light sources in such a manner that clock pulses of a first clock pulse sequence have a time shift with respect to clock pulses of a second clock pulse sequence. The control device can be formed as an electronic circuit, a correspondingly programmed processor unit, combinations thereof or the like. The control device can further be formed by a semiconductor chip.

The clock pulse sequences are preferably each associated with a single semiconductor light source. However, it can also be provided that the clock pulse sequences are associated with two or more semiconductor light sources. This configuration is in particular expedient when semiconductor light sources are to be controlled combined in groups. Various embodiments are naturally not restricted to the application with two semiconductor light sources but can in particular naturally expediently be used with luminous means having a plurality of semiconductor light sources. Particularly with a very large number of semiconductor light sources of the luminous means, the advantages according to various embodiments appear particularly clearly. Basically, its own individual clock pulse sequence can be provided for each semiconductor light source.

In this case, each semiconductor light source is connected directly to the control device so that a clock pulse sequence associated with the semiconductor light source can be applied to said control device.

It can naturally also be provided that a predefined number of semiconductor light sources is jointly wired electrically and is jointly connected to a connection of the control device. In this case, the semiconductor light sources connected jointly to the control device can be jointly controlled by an individual clock pulse sequence common to this group. As a result of the joint wiring, a fixedly set hardware group is formed, which is always controlled jointly by a single clock pulse sequence. Furthermore, individual semiconductor light sources connected individually to the control device can naturally, if desired, also be exposed to the same clock pulse pattern by the control device. As a result, specific light effects can be achieved. In particular, a mixed mode can be provided in which some of the semiconductor light sources are exposed to individual clock pulse patterns and others are exposed to a joint clock pulse pattern.

The time shift of the clock pulse sequences can be selected in such a manner that clock pulses of different clock pulse sequences overlap or do not overlap. Furthermore, it can be provided that a clock pulse sequence has time-variable clock pulses, which differ from one another both with regard to their duration and also with regard to their time interval from neighboring clock pulses. For example, it can be provided that a clock pulse sequence can be shifted over a variably adjustable time with respect to another clock pulse sequence. Preferably more than two clock pulse sequences are provided, which accordingly have a time shift with respect to one another. However, it can also be provided that in the case of more than two clock pulse sequences, only two of the clock pulse sequences have a time shift with respect to one another. Other combinations can also be provided in this respect.

An advantage of the technical features described is that a reduction in requirements for the controllable electronic clocked energy converter can be achieved. The dynamics of the current stressing or power stressing can be reduced by interpolation of image transitions or pulse patterns by means of intermediate values or adaptation of load jumps to actually required dynamics. As a result of the shift of PWM cycles of the individual semiconductor light sources with respect to one another, a reduction of the maximum total current to be provided over the entire semiconductor light source structure of the luminous means is obtained.

Both measures allow a more efficient design of the controllable, electronic clocked energy converter because this does not need to map the complete dynamics of the system which is formed by the luminous means and a power reserve can be reduced. By this means, the complexity of the controllable electronic clocked energy converter can be reduced, with the result that costs can be saved.

Furthermore, feedback effects on an energy supply network or the electrical energy source can be reduced. In particular, filter expenditure can be reduced.

Accordingly, on the method side, various embodiments in particular propose a method for controlling a luminous means having at least two semiconductor light sources and connected to an electrical energy source, wherein
the luminous means converts an electrical power provided by the electrical energy source by means of the semiconductor light sources into an emitted luminous power dependent upon the electrical power provided,
the provided electrical power is adjusted by means of a control device, whereby the electrical power is applied to the semiconductor light sources by means of the control device in a clocked mode,
the semiconductor light sources are controlled according to clock pulse sequences individually associated with the semiconductor light sources, wherein
clock pulses of a first clock pulse sequence have a time shift with respect to clock pulses of a second clock pulse sequence.

The advantages and configurations mentioned for the control device apply equally for the method according to various embodiments.

It proves to be particularly advantageous according to a further aspect of various embodiments if the clock pulses of a first clock pulse sequence lie in clock intervals of a second clock pulse sequence. In this case, a particularly favorable loading on the electrical side of the luminous means can be achieved because peak powers or peak currents can be reduced.

This also proves to be particularly advantageous if the semiconductor light sources have substantially the same physical properties. However, even in the case of different physical properties, advantageous aspects can be implemented with various embodiments. With this aspect, it can furthermore be achieved that circuit feedback, for example harmonics on the electrical side, can be reduced.

According to a further aspect of various embodiments, it is proposed that one, preferably each, clock pulse of the first clock pulse sequence is in each case followed directly in time by a clock pulse of the second clock pulse sequence. By this means, a further improvement can be achieved on the electrical side of the luminous means since, on the one hand, a power stressing or current stressing can be further reduced and, at the same time, it can also be achieved that high-frequency currents can be reduced.

According to a further embodiment of various embodiments, it is proposed that the clock pulses of the first clock pulse sequence last for a time duration different from the clock pulses of the second clock pulse sequence. This allows the semiconductor light sources exposed to the respective clock pulse sequence to be operated at a different power so that the corresponding semiconductor light sources generate a different luminous power.

The term power in the sense of this application means an average power, which is determined by means of a time averaging, the duration of which is significantly greater than the duration of a clock period of the respective clock pulse sequence, for example for five, ten, or even more clock periods of the clock pulse sequence.

The power defined in this sense can be applied both to the electrical side and also to the light engineering side. Preferably the duration of the averaging is determined in such a manner that the light emission of the corresponding semiconductor light sources brought about by a clock pulse sequence produces a continuous visual effect on the human eye in a present substantially stationary light-generating state if the clock pulse sequence is a stationary clock pulse sequence, which is associated with a corresponding power and thereby defines a corresponding operating state.

A further aspect of various embodiments proposes that the clock pulse sequences form a common pulse pattern and the luminous power emitted by the luminous means is adjusted by selecting a pulse pattern associated with the luminous power. In this way, a particularly simple control can be achieved, in particular if the luminous means has a large number of semiconductor light sources, which requires a likewise large number of clock pulse sequences. For example, such pulse patterns can be stored in advance, so that a very rapid adjustment of the luminous means to the desired luminous power can be achieved without expensive signal processing measures being required to determine the respective clock pulse sequences. As a result, expenditure on the control device side can be reduced.

According to a further development, it is proposed that in order to vary the luminous power emitted by the luminous means, a switchover is made from a first pulse pattern associated with a first emitted luminous power to a second pulse pattern associated with a second emitted luminous power. It is thereby possible to vary the emitted luminous power of the luminous means in a desired manner in a particularly simple manner. For example, pre-stored pulse patterns can be used so that a signal processing expenditure, in particular computer expenditure, can be reduced. However, it proves to be particularly advantageous if an algorithm is used to determine suitable pulse patterns in order to determine pulse patterns depending on the desired light distribution. On the basis of the algorithm, a computer program can be created, which allows the processor unit of the clock generator to be able to determine a plurality of different pulse patterns without major expenditure of time. Likewise it can be provided that a field programmable gate array (FPGA) is programmed according to such an algorithm and when used in the clock generator determines and provides the pulse pattern corresponding to the desired light distribution.

Furthermore, it is proposed by various embodiments that the switchover from the first to the second pulse pattern includes an interposition of at least a third pulse pattern, which is associated with a luminous power between the first and the second luminous power. It is thereby possible to influence switching processes between the first pulse pattern and the second pulse pattern so that large current and/or light fluctuations can be reduced. Furthermore, a gentle, ergonomically visually favorable switchover or variation of the luminous power can thereby be achieved. Finally requirements for the electrical energy source, in particular for the electronic clocked energy converter, can be further reduced.

It proves to be particularly advantageous that with various embodiments, the electrical power provided by the electrical energy source is converted by means of an electronic clocked energy converter, wherein the electronic clocked energy converter is proactively controlled by means of the control device. By this means, expenditure relating to the electronic clocked energy converter can be further reduced because the converter can be adapted accordingly to the preceding variation of the energy provision. As a result, not only expenditure relating to the energy converter and optionally filtering can be reduced, but a more favorable transition relating to the power variation of the luminous means can also be achieved. Proactive means that the electronic clocked energy converter is adaptively adapted to the preceding stressing before the onset of a change in stressing, in particular a power variation.

A further development provides that the proactive control includes a transmission of a suitable control signal to the electronic clocked energy converter before a clock pulse sequence and/or a pulse pattern is activated by means of the control device. By this means, the electronic clocked energy converter can be adapted even better to the variation.

Finally, various embodiments propose in particular a computer program product including a program for a processor unit of a clock generator of a control device, wherein the program has program code sections of a program for executing the steps of the inventive method, when the program is executed by the processor unit.

The aforesaid computer program product can be configured as a computer-readable storage medium. Furthermore, the program can be loaded directly into an internal memory of the processor unit. Thus, for example, it is possible to download the program from a network, from a data source, for example a server, and load it into an internal memory of the processor unit, so that the computer can execute the program.

Preferably the computer program product includes a computer-readable medium, on which program code sections are stored. Such a computer-readable medium can, for example, be a memory module, a compact disc, a USB stick, or the like.

### BRIEF DESCRIPTION OF THE DRAWINGS

In the drawings, like reference characters generally refer to the same parts throughout the different views. The drawings are not necessarily to scale, emphasis instead generally being placed upon illustrating the principles of the disclosed embodiments. In the following description, various embodiments described with reference to the following drawings, in which:

FIG. 1 shows in a schematic view a vehicle headlamp as lighting device with a light-emitting diode array as luminous means, wherein the light-emitting diodes as semiconductor light sources are wired into arrays in a first operating state,

FIG. 2 shows the vehicle headlamp according to FIG. 1 in a second operating state,

FIG. 3 shows a schematic circuit diagram for a control device according to various embodiments,

FIG. 4 shows a schematic diagram of a percentage fraction of a respective gray scale on a base light distribution of the headlamp according to FIG. 1,

FIG. 5 shows a schematic diagram in an upper diagram of a time profile of an electrical current for a luminous means as well as in a lower diagram a diagram with corresponding clock pulse sequences for the respective light-emitting diodes,

FIG. 6 shows a diagram as in FIG. 5, wherein the clock pulse sequences are selected according to various embodiments,

FIG. 7 shows schematically two diagrams arranged one above the other, wherein an upper diagram shows a current consumption of the luminous means over time for different pulse patterns and the lower diagram shows a diagram relating to a change of the phase position of PWM channels for the individual light-emitting diodes,

FIG. 8 shows two diagrams arranged one above the other, wherein an upper diagram shows the current consumed by the luminous means over time and the lower diagram shows corresponding control signals for light-emitting diodes of the luminous means over time,

FIG. 9 shows two diagrams arranged one above the other as in FIG. 8, wherein the upper diagram shows schematically a current profile with interposed pulse patterns and the lower diagram shows correspondingly assigned control signals for the light-emitting diodes of the luminous means,

FIG. 10 shows a schematic block diagram for an electronic circuit of a register arrangement for actuating eight light-emitting diodes,

FIG. 11 shows a logic table based on a register actuation according to FIG. 7 for control signals for the eight light-emitting diodes, which are generated with the register set according to FIG. 10,

FIG. 12 shows a diagram as in FIG. 11, wherein the PWM channels for the light-emitting diodes are shifted according to various embodiments,

FIG. 13 shows a schematic diagram of pulse patterns for switching on the luminous means,

FIG. 14 shows a switch-on process as in FIG. 13, but with interposition of pulse patterns according to various embodiments,

FIG. 15 shows schematically a conventional actuation as in FIG. 13, and

FIG. 16 shows a schematic view of another configuration of various embodiments, in which a plurality of pulse patterns are interposed when switching on the luminous means to implement a dimming function.

### DETAILED DESCRIPTION

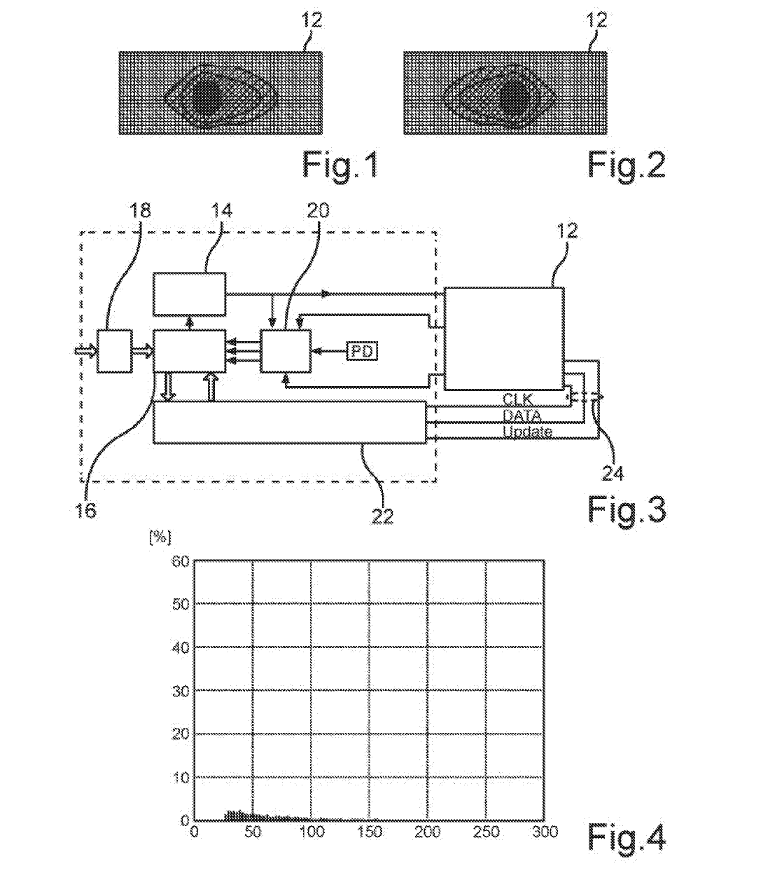

FIG. 1 shows in a schematic view a plan view of a luminous means 12 with a plurality of light-emitting diodes wired to form an array, which luminous means is provided for installation in a vehicle headlamp of a vehicle. FIG. 1 shows a first light distribution of the vehicle headlamp in a first operating state. FIG. 2 shows the same headlamp but now in a second operating state, in which a changed light pattern with respect to FIG. 1 is activated. The luminous means 12 has a flat substrate, not shown, which provides a surface on which the plurality of light-emitting diodes is arranged adjacent to one another in a grid-like manner. The light-emitting diodes are connected individually to a control device 10 (FIG. 3).

By this means it is possible to individually actuate each light-emitting diode of the luminous means 12, in order to achieve desired lighting effects as required.

As a result of a dynamically varying light distribution of the luminous means 12, a load distribution also varies over the structure of the luminous means 12. As a result of the application as a vehicle headlamp, in the present case a time-averaged current requirement of about 13 to 18 A is obtained with a typical light distribution, as shown in FIGS. 1 and 2. At maximum luminous power, a current consumption in a range of 33 to 46 A is provided. The difference between the two values corresponds to the reserve, which for example is to be held in readiness for an illumination when negotiating bends. From this it follows that the current distribution or power distribution also varies dynamically over the luminous means 12 depending on the driving situation.

The possibilities of this vehicle headlamp are also used for safety-relevant functions, for example spotlights for marking sources of danger.

As a result of the use of light-emitting diodes for semiconductor light sources, the time constants for a variation of the current distribution in the luminous means 12 are small. In the present case, the light-emitting diodes have substantially the same physical properties. In the present case, it is provided that the luminous means 12 has a plurality of light-emitting diodes, and specifically 3,000 light-emitting diodes. In alternative exemplary embodiments, naturally more than 3,000 light-emitting diodes can also be provided for a luminous means 12. The light-emitting diodes of the luminous means 12 are connected in parallel and can be actuated individually with PWM as a clock pulse sequence on the side of the control device 10. As will be explained further in the following, the control device 10 for this purpose includes an electronic clocked energy converter, which in the present case is configured as a step-down converter 14.

FIG. 3 shows in schematic view a block diagram of the control device 10. The control device 10 is connected to the luminous means 12 so that all the light-emitting diodes of the luminous means 12 can be controlled individually by the control device 10. The control device 10 further includes the step-down converter 14, which provides the electrical power for operation of the light-emitting diodes of the luminous means 12. Finally, the control device 10 includes a processor unit 16, which is connected to an interface circuit 18, via which a connection to an external communication network is possible.

Furthermore, the processor unit 16 is connected to the step-down converter 14 and delivers control signals for the operation thereof. Finally the processor unit is connected to an analog signal processing unit 20, which processes signals of the luminous means 12 and also of the step-down converter 14, and delivers corresponding signals to the processor unit 16. Furthermore, the processor unit 16 is connected to a clock generator 22, which according to a specification of the processor unit 16 generates clock signal sequences in the sense of various embodiments and outputs these for controlling the light-emitting diodes of the luminous means 12 to the luminous means 12. Furthermore, the clock generator 22 can deliver signals to the processor unit 16, for example, relating to current operating states, clock pulse patterns currently assigned to the light-emitting diodes, and/or the like. It is not shown in FIG. 3 that the step-down converter 14 is connected to an electrical on-board network of a motor vehicle, from which it obtains the electrical energy for operating the control device 10 as well as the luminous means 12.

In the present case, it is provided that a specified current or a specified power can be applied individually to each light-emitting diode. For this purpose, the clock generator 22 has corresponding switching elements, which are not shown. The control of a medium brightness of the respective light-emitting diodes of the luminous means 12 is implemented by means of a clock pulse sequence, based on PWM. As a result of the plurality of light-emitting diodes, here 3,000, the actuation of the light-emitting diodes is not accomplished directly via switching elements but via a serial interface 24. The corresponding switching elements are instead arranged in the luminous means 12 itself. The clock generator 22 therefore inter alia has the task of performing a signal pre-processing within the system. This includes the fact that the implementation and creation of a light distribution of the luminous means 12 is accomplished into a suitable PWM actuation matched to the respective single individual light-emitting diode of the luminous means 12. The clock generator 22 obtains corresponding parameters from the processor unit 16. The processor unit 16 furthermore has the function within the system of controlling the step-down converter 14, evaluating analog signals, and supplying them to the clock generator 22 for further processing.

The processor unit 16 can be configured as a parallel-operating unit with high processing speed. In the present case, it is formed by a semiconductor chip, which is part of an electronic circuit of the control device 10.

Within the previously described system the combination of a plurality of clocked light-emitting diodes presents a particular challenge for the design of the step-down converter 14. This is illustrated by means of a diagram according to Fig. for the luminous means 12 as a vehicle headlamp. In this embodiment, it is provided that approximately 45% of the available light-emitting diodes of the luminous means 12 are switched within a cycle time of at most 5 ms (200 Hz). A change in brightness of the base light distribution shown in FIG. 4 is achieved in the present case by PWM. The non-activated 55% of the available light-emitting diodes is thus available in order to implement further lighting functions, for example safety functions, pivot functions, or the like, and specifically without mechanical movements needing to be implemented.

If an operating current of 10 milliampere is applied for an individual light-emitting diode and in each case 1,000 light-emitting diodes are jointly supplied with electrical energy by a step-down converter 14, with a 45% utilization this results in a pulsed current of 4.5 A. This current is to be provided in a 5 ms rhythm, which is why this boundary condition should be taken into account for the design of the step-down converter 14 as an essential condition. If on the other hand, the current is considered which is used within the said 5 ms averaged over time, a value of approximately 1.33 A would be obtained. This value is significantly lower, which is why, when implementing such a value, the step-down converter 14 could be reduced significantly with regard to its hardware design.

A feature of various embodiments is that a time shift of the PWM cycles, that is the clock pulse sequences, can be achieved for the individual light-emitting diodes among one another, so that load jumps at the beginning of a cycle can be reduced significantly. Furthermore, the possibility is opened up of designing transitions between two light states of the luminous means 12 through intermediate images or corresponding pulse patterns and interpolation which can thereby be achieved, in such a manner that time dynamics of a current variation can be reduced significantly. Furthermore, a system architecture is thereby obtained which can enable a prospective, that is, proactive control of the step-down converter 14.

Various embodiments use this finding to actuate the light-emitting diodes asynchronously, that is, to control them with individually assigned clock pulse sequences, so that clock pulses of the first clock pulse sequence have a time shift with respect to clock pulses of a second clock pulse sequence. Preferably this applies for a plurality of, in particular all the clock pulse sequences, which are used to control the light-emitting diodes of the luminous means 12. Naturally a plurality of light-emitting diodes of the luminous means 12 can also be operated at the same time with one clock pulse sequence in order to limit the number of different clock pulse sequences.

Overall, one aspect of various embodiments is to be able to achieve as far as possible a largely time-constant current consumption. For example, this means that in the case of four light-emitting diodes with a predefined average brightness of 25%, these light-emitting diodes are not switched synchronously but consecutively with a time shift, or in a clocked manner. The current amplitude in such a circuit is thus reduced to ¼ of the total current which would occur in the case of the simultaneous activation of the light-emitting diodes. As a result, peak currents and amplitudes of current jumps can be reduced, with the result that the transient requirements for the step-down converter 14 also decrease. This results in a significant reduction of costs and overall size, since for example simpler coils with lower inductance can be used. Furthermore, the efficiency of the step-down converter 14 can be improved.

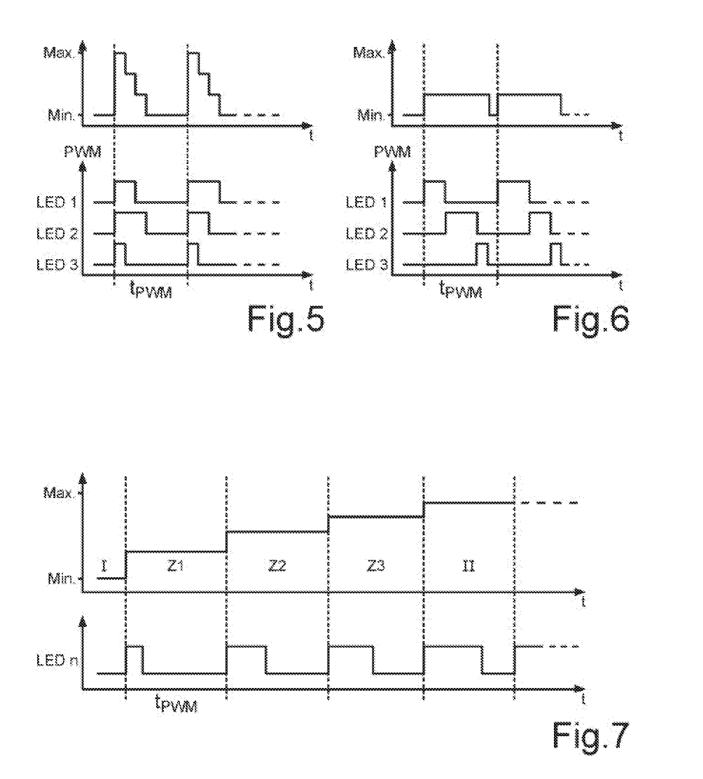

FIG. 5 shows, for example, two time diagrams arranged one above the other, which schematically show a current profile over time for a total current from three light-emitting diodes, which are controlled accordingly according to the lower diagram. It can be identified that in a short time interval at the beginning of the time interval t_{PWM}, a current three times higher than the current of an individual light-emitting diode is established. FIG. 6 shows a diagram as in FIG. 5 but unlike FIG. 5, the operating times of the three light-emitting diodes are shifted accordingly, so that they do not overlap. This results in the current profile shown in the upper diagram in FIG. 6, which merely requires a current requirement at the level of the current of one light-emitting diode.

In the method according to various embodiments shown in FIG. 7, the motivation is also to reduce the requirements for the step-down converter 14 by avoiding large current jumps.

FIG. 7 shows two diagrams arranged one above the other, wherein the change from an operating state I to an operating state II of the luminous means 12 is to be achieved. The upper diagram in FIG. 7 shows the current consumption of the luminous means 12 whereas the lower diagram in FIG. 7 shows the corresponding control signals for the light-emitting diodes. Starting from the operating state I, an intermediate image Z1 is initially produced with a first control signal, which results in a current consumption of the luminous means 12, which is greater than that of the operating state I but smaller than that of the operating state II. In a next PWM cycle, a second intermediate image Z2 is activated, which results in a current consumption of the luminous means 12, which is greater than that of the intermediate image Z1 but smaller than that of the operating state II. In a following cycle, an intermediate image Z3 is generated, which results in a current consumption of the luminous means 12, which is greater than that of the intermediate image Z2 but smaller than that of the operating state II. The operating state II is only achieved in a following cycle. Through this measure, a steep and large current rise and the associated loads are avoided. In the present case, the cycle time is approximately 5 ms.

This configuration is suitable, for example, for the case of using the vehicle headlamp as part of a flasher function. In this case, use is made of the connection which exists between a PWM cycle and a time requirement within the application as a vehicle headlamp. For an exemplary cycle time of 5 ms and a time interval of 50 ms for achieving the new operating state, it is accordingly possible to use 10 intermediate images or pulse patterns for the transition from one operating state to the other operating state in order to thereby reduce an amplitude of current jumps. This has the result that in the case of a significant change in the operating state, a stepwise approximation by intermediate states in the form of pulse patterns is achieved. As shown in FIG. 8, this procedure can also be used for switching on the vehicle headlamp.

FIG. 8 shows two diagrams arranged one above the other, which show the switching on of the vehicle headlamp over time. The upper diagram shows the actual current of the luminous means 12 in each case over time, when the light-emitting diodes are controlled accordingly according to the lower diagram. It can be seen that in this case, a large current jump takes place when switching on at the time point tₒₙ.

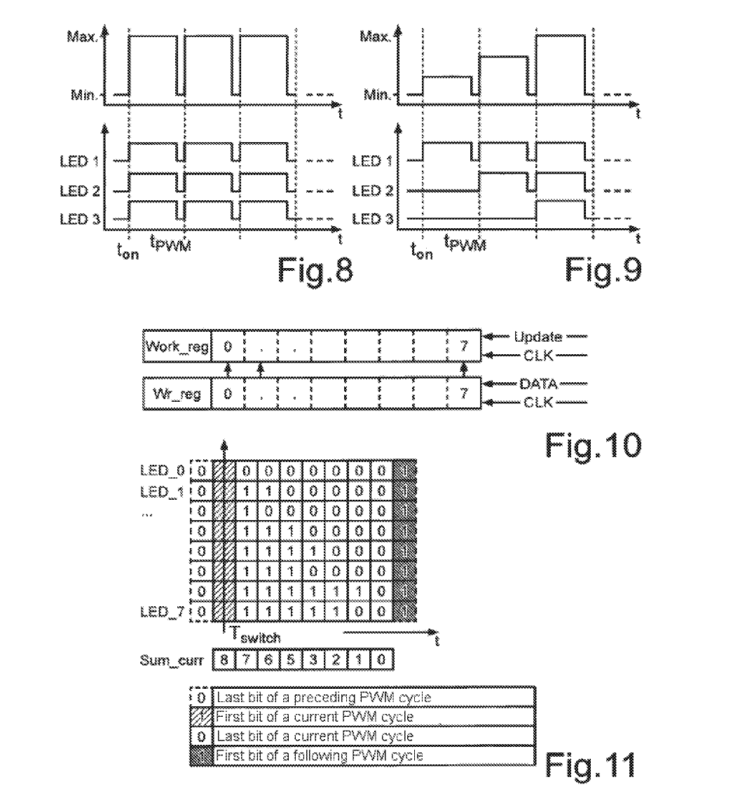

FIG. 9 now shows two diagrams as in FIG. 8, wherein a switching on state is again shown here, wherein however this is configured according to various embodiments. It can be seen that the light-emitting diodes LED1 to LED3 are not switched on simultaneously at the time point tₒₙ, as in the embodiment according to FIG. 8 but merely the light-emitting diode LED1. The light-emitting diode LED2 is then only additionally switched on in a following cycle and the light-emitting diode LED3 is switched in a following cycle thereto. A correspondingly staircase-like rise in the current profile can be seen in the upper diagram of FIG. 9. The large current jumps such as are formed during a switching on according to FIG. 8 can thereby be avoided.

A further embodiment of various embodiments is obtained whereby pulse patterns for implementing intermediate images are not linearly interpolated in order, for example, to correspond to the nature of the human eye and be able to provide an ergonomically favorable, visual impression.

Since the information is available as to which operating state of the luminous means 12 should be adopted and optionally which intermediate images are provided to reach this operating state, it is possible to prepare the step-down converter 14 for the corresponding load variation.

If the average current consumption of the luminous means 12 is increased, for example, due to the variation of the operating state of the luminous means 12, it is possible to accordingly adapt the output voltage as well as also the converter frequency prospectively or proactively. It can thereby be achieved that when the load variation arrives at the step-down converter 14, a sharp decline, for example, of the output voltage can be reduced significantly. As a result, a reduced residual ripple of the current of a respective light-emitting diode of the luminous means 12 can also be achieved because a relationship exists between the electrical voltage applied to the light-emitting diode and the electrical current flowing through it. Furthermore, it is possible to better operate the step-down converter 14 by adapting control parameters with regard to its efficiency.

For the technical implementation, for example, a register set can be used for actuation of the light-emitting diodes of the luminous means 12, as is shown schematically for example by reference to FIG. 10 for the actuation of eight light-emitting diodes and as is comprised by the control device 10 in the present case. FIG. 10 shows a two-part register set in schematic view. The register set according to FIG. 10 includes a write register Wr_reg into which data are written serially. In this case, each bit of this register represents the operating state of a single light-emitting diode. For this purpose, the write register Wr_reg has an input connection DATA and a clock input CLK. In a known manner, data are written serially into the write register.

The register set according to FIG. 10 further includes a work register Work_reg connected to the write register, which is connected to the write register Wr_reg. The data written into the write register are transmitted to corresponding memory cells of the work register Work_reg and specifically by applying a corresponding acceptance signal to a corresponding control input. This signal is characterized in FIG. 10 by Update. The corresponding switching elements for energizing the corresponding light-emitting diodes are connected to the work register Work_reg. If the register content of the work register Work_reg contains a logic 1, current is applied to the correspondingly assigned light-emitting diode so that it generates light. If, on the other hand, there is a logic 0 in a corresponding register cell, the correspondingly assigned light-emitting diode is not energized. As a result of the variation of the values stored in the memory cells of the work register Work_reg by means of the write register Wr_reg combined with the Update signal, an individual clock pulse sequence, here PWM, can be mapped for each light-emitting diode. The work register Work_reg also has a clock input CLK, which can preferably be actuated by the same clock signal as the write register Wr_reg.

FIG. 11 now shows a tabular view of switching states of eight light-emitting diodes, as can be actuated with the register set according to FIG. 10. The upper square block shows in columns the logic values contained in the work register Work_reg at the respective time points for the respective light-emitting diodes according to one exemplary embodiment. The values shown in the block can naturally be adapted accordingly if required for the desired generation of a luminous power of the luminous means 12. Shown below the uppermost block diagram is a line, which shows the logic-normalized total current. Shown below this line is a legend for the different signs in the uppermost block. As can be seen from FIG. 11, a time point is marked with a vertical arrow. At this time point, all eight light-emitting diodes are switched on simultaneously. At the following time points, the number of active light-emitting diodes is reduced in a stepwise manner so that the normalized current loading shown below is obtained.

These facts have the result that a large switch-on current is produced, as has already been explained previously with reference to FIGS. 5 and 6.

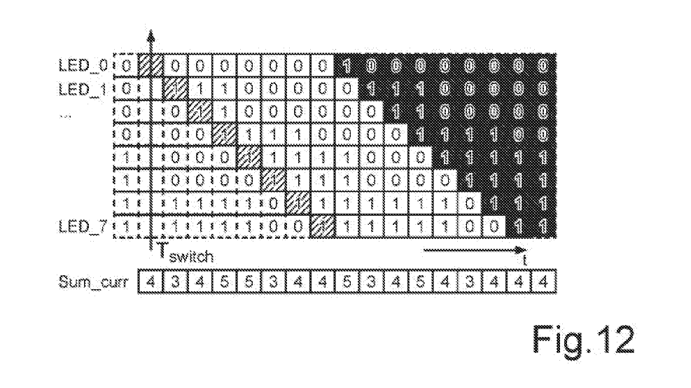

FIG. 12 now shows an arrangement as FIG. 11 but in this arrangement, the clock pulse sequences provided for the light-emitting diodes have a time shift with respect to one another. It can be seen from FIG. 12 that with the shift shown there, the normalized total current in each clock cycle is between the values 3 and 5. Through this asynchronicity of the clock pulse sequences for the light-emitting diodes, a homogenization of the current consumption of the luminous means 12 can thus be achieved. It follows from the total current line shown under the block in FIG. 12 that the total current values 0 to 2 and 6 to 8 do not occur. This is advantageous for the current stressing of the remaining circuit, in particular the control device 10.

The shift of the clock pulse sequences with respect to one another is accomplished by a logic inside the clock generator 22.

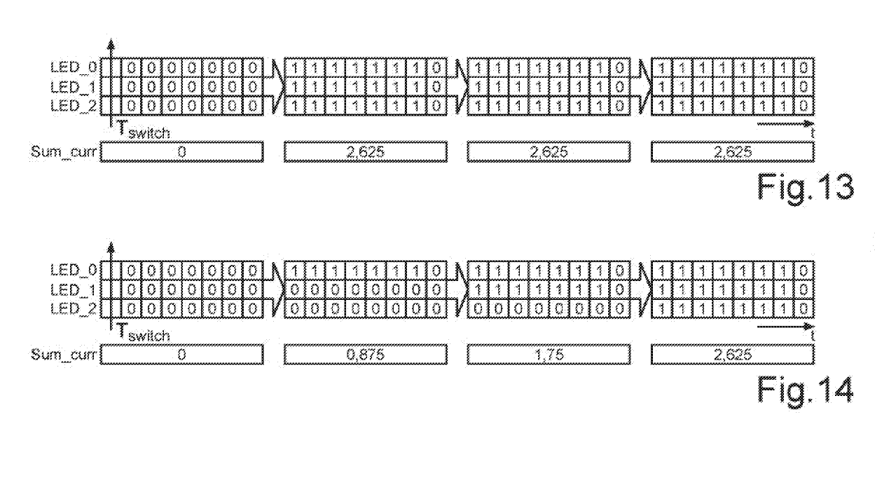

FIGS. 13 and 14 show a switching-on of the luminous means 12 in comparison. FIG. 13 shows a switching-on process for three light-emitting diodes of the luminous means 12, which are switched on jointly in a conventional manner, and specifically from a power of 0 to a power of 87.5%. For the diagram four temporally successive blocks with logic switching values are shown, as have already been explained with reference to FIGS. 11 and 12. In the present case, only three light-emitting diodes are provided, which are switched accordingly. Basically however, this can be applied to any number of light-emitting diodes.

Here also again a power control by means of PWM is provided. This is obtained from the four adjacently depicted blocks which follow consecutively in time in FIG. 3. In the first left block, all the light-emitting diodes are switched off during the first PWM cycle formed by the first block. At the end of the first cycle, that is, with the transition to the second block following the left block, all three light-emitting diodes are switched on simultaneously. The switched-on state applies over seven cycles. As the eighth cycle all three light-emitting diodes are switched off simultaneously. This corresponds to a switch-on ratio of 87.5%. The second block is followed in time by an identical second and third block. It can be seen that the three light-emitting diodes are switched on and off synchronously. The normalized current values are again given underneath the respective blocks, which are averaged over the duration of each block.

FIG. 14 now shows a modification according to various embodiments with two intermediate images as pulse patterns, which also represent a switching-on process as in FIG. 13. The power assigned to the intermediate images is lower than the power in the switched-on state, wherein the power increases with each further intermediate image so that a substantially staircase-like profile of the power increase is the result.

Unlike the switching-on process according to FIG. 13, in the switching-on process according to FIG. 14, the three light-emitting diodes are not simultaneously switched on at once. The diagram in FIG. 14 corresponds in principle to the diagram in FIG. 13, which is why reference is additionally made in this respect to FIG. 13. Firstly in a left block in FIG. 14, all three light-emitting diodes are switched off over the entire PWM period. In the transition from the left block to the right adjacent block, initially only the uppermost light-emitting diode LED 0 is switched on and specifically with a clock ratio as in FIG. 13. Again shown under the block, as in FIG. 13, is the average normalized current of this PWM cycle. Accordingly, a normalized current of 0.875 is obtained since the light-emitting diode LED 0 is switched on over seven of the eight periods of the PWM cycle. This operating state corresponds to a first intermediate image or first pulse pattern. This is followed immediately by a following block in which, in addition to the uppermost light-emitting diode LED 0, the middle light-emitting diode LED 1 is now also activated at the same time. As a result, a further intermediate image is given. A corresponding current stressing of 1.75 is obtained. Finally, the fourth block follows, in which all three light-emitting diodes are switched on synchronously. Accordingly, the switched-on state is now achieved as in FIG. 13.

It can be seen from FIG. 14 that the switching-on load jump, such as occurs in FIG. 13, can be reduced by the control according to FIG. 14, that is, a sequential switching of light-emitting diodes. The load, that is, the current, changes its value in a step-like manner from 0 to the value in the switched-on state and specifically according to the light-emitting diodes switched on in each following cycle. In FIG. 14 the switch-on time points of the light-emitting diodes are therefore shifted in time and specifically in this exemplary embodiment by a PWM cycle in each case. The sequential shift of the switch-on time points of the light-emitting diodes is in the present case also implemented by the clock generator 22.

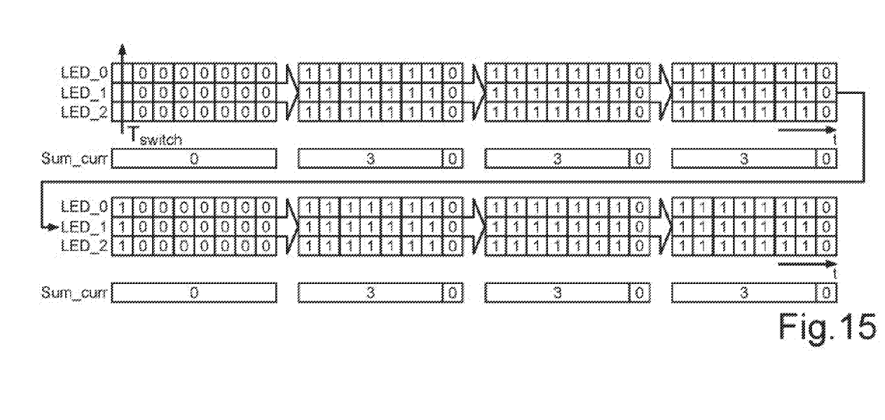

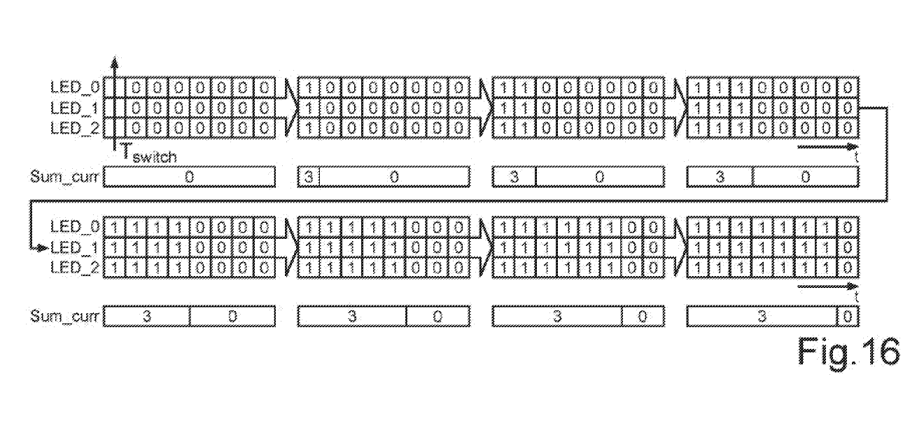

A further embodiment of various embodiments is obtained from FIGS. 15 and 16. These relate to the dimming of light-emitting diodes of the luminous means 12 also with reference to three selected light-emitting diodes.

FIG. 15 shows a conventional switching-on process, of which eight PWM cycles immediately following one another, are shown schematically in the logic block diagram. Again a respective normalized total current is given below the respective blocks, wherein the normalized total current is here related to the respective clock cycle in a cycle-related manner. It can be seen that, as in FIG. 13, the first left block at the top in FIG. 15 is occupied by zeros so that the light-emitting diodes are switched off in this PWM cycle. On changing to the right adjacent block, all the light-emitting diodes are switched on, as shown in FIG. 13. The clock-related normalized total current is therefore 3. Here also the power is set to 87.5% since the clock ratio of the PWM cycle is seven eighths. This is followed by six further, identical PWM cycles. In relation to the effects, reference is additionally made to the explanations to FIG. 13.

FIG. 16 now shows a switching-on process as in FIG. 15, where here the three light-emitting diodes are dimmed accordingly. The upper left block is again a switched-off PWM cycle in which all three light-emitting diodes are switched off. This is followed adjacently on the right by a block, in which a switching-on process is introduced. It can be seen that the three light-emitting diodes are initially jointly switched on for a first clock of the PWM cycle, whereby a first intermediate image is given. In the remaining seven clocks of the PWM cycle, the light-emitting diodes are switched off. This is followed adjacently on the right by a further block, in which in two successive clock periods the light-emitting diodes are already switched on, whereby a second intermediate image is given. In the remaining clocks of this PWM cycle all three diodes are switched off again. This is followed adjacently on the right by a fourth PWM cycle, which begins with the three light-emitting diodes being switched on over the three first clocks of the PWM cycle, whereby a third intermediate image is given. Finally, this is directly followed by four further PWM cycles in a lower block diagram, in which in each case the switched-on state is lengthened by a clock with continuing number of the PWM cycle, and which form corresponding intermediate images. Finally at the bottom right in the block the switching state is achieved as in FIG. 13 in the right block. An extreme load jump can also be avoided here if the brightness values of the light-emitting diodes can be interpolated or dimmed. The dimming of the light-emitting diodes can also be implemented by the clock generator 22.

Naturally the previously described exemplary embodiments can also be combined with one another in an expedient manner in order to arrive at further embodiments within the framework of various embodiments.

An advantage of the described technical features is that a reduction in requirements for the step-down converter 14 can be achieved. Through the interpolation of image transitions or pulse patterns by means of intermediate values or adaptation of load jumps to the actually required dynamics, the dynamics of the current stressing or power stressing can be reduced. As a result of the shift of the PWM cycles of the individual light-emitting diodes with respect to one another, a reduction in the maximum total current to be provided over the entire light-emitting diode structure of the luminous means 12 is obtained.

Both measures enable a more efficient design of the step-down converter 14 because this no longer needs to map the complete dynamics of the system formed by the luminous means 12 and a power reserve can be reduced. By this means, the complexity of the power electronics of the step-down converter can be reduced, whereby costs can be saved.

Furthermore, feedback effects on an energy supply network or the electrical energy source can be reduced. In particular, filter expenditure can be reduced.

Naturally individual features can be combined with one another in any manner as required in order to arrive at further embodiments in the sense of various embodiments. In particular, this naturally relates to features of the dependent claims. Furthermore, device features can naturally also be specified by corresponding process steps and vice versa.

While the disclosed embodiments have been particularly shown and described with reference to specific embodiments, it should be understood by those skilled in the art that various changes in form and detail may be made therein without departing from the spirit and scope of the disclosed embodiments as defined by the appended claims. The scope of the disclosed embodiments is thus indicated by the appended claims and all changes which come within the meaning and range of equivalency of the claims are therefore intended to be embraced.

1. A control device for a luminous means comprising at least two semiconductor light sources and which is configured to be connected to an electrical energy source for conversion of an electrical power provided by the electrical energy source by means of the semiconductor light sources into an emitted luminous power dependent upon the electrical power provided, wherein the semiconductor light sources are connected to the control device and the control device is adapted to adjust the electrical power provided, whereby the control device has a clock generator, which is configured to apply electrical power to the semiconductor light sources in a clocked mode, wherein the clock generator is adapted to control the semiconductor light sources according to clock pulse sequences individually associated with the semiconductor light sources in such a manner that clock pulses of a first clock pulse sequence have a time shift with respect to clock pulses of a second clock pulse sequence.

2. The control device as claimed in claim 1, further comprising an electronic clocked energy converter controllable by means of the control device.

3. The control device as claimed in claim 1, wherein the semiconductor light source comprises a light-emitting diode or a laser diode.

4. A lighting device having a luminous means comprising a plurality of semiconductor light sources, an electrical connection for connecting the lighting device to an electrical energy source as well as a control device, to which the semiconductor light sources are connected, the control device having at least two semiconductor light sources and which is connected to an electrical energy source for conversion of an electrical power provided by the electrical energy source by means of the semiconductor light sources into an emitted luminous power dependent upon the electrical power provided, wherein the semiconductor light sources are connected to the control device and the control device is adapted to adjust the electrical power provided, whereby the control device has a clock generator, which is configured to apply electrical power to the semiconductor light sources in a clocked mode, wherein the clock generator is adapted to control the semiconductor light sources according to clock pulse sequences individually associated with the semiconductor light sources in such a manner that clock pulses of a first clock pulse sequence have a time shift with respect to clock pulses of a second clock pulse sequence.

5. A method for controlling a luminous means having at least two semiconductor light sources and connected to an electrical energy source, wherein
the luminous means converts an electrical power provided by the electrical energy source by means of the semiconductor light sources into an emitted luminous power dependent upon the electrical power provided,
the provided electrical power is adjusted by means of a control device, whereby the electrical power is applied to the semiconductor light sources by means of the control device in a clocked mode,
the semiconductor light sources are controlled according to clock pulse sequences individually associated with the semiconductor light sources,
wherein clock pulses of a first clock pulse sequence have a time shift with respect to clock pulses of a second clock pulse sequence.

6. The method according to claim 5, wherein the clock pulses of a first clock pulse sequence lie in clock intervals of a second clock pulse sequence.

7. The method as claimed in claim 5, that wherein one, clock pulse of the first clock pulse sequence is in each case followed directly in time by a clock pulse of the second clock pulse sequence.

8. The method as claimed in claim 5,
wherein the clock pulses of the first clock pulse sequence last for a time duration different from the clock pulses of the second clock pulse sequence.

9. The method as claimed in claim 5, wherein the clock pulse sequences form a common pulse pattern and the luminous power emitted by the luminous means is adjusted by selecting a pulse pattern associated with the luminous power.

10. The method as claimed in claim 9, wherein in order to vary the luminous power emitted by the luminous means, a switchover is made from a first pulse pattern associated with a first emitted luminous power to a second pulse pattern associated with a second emitted luminous power.

11. The method as claimed in claim 10, wherein the switchover from the first to the second pulse pattern comprises an interposition of at least a third pulse pattern, which is associated with a luminous power between the first and the second luminous power.

12. The method as claimed in claim 5, wherein the electrical power provided by the electrical energy source is converted by means of an electronic clocked energy converter, wherein the electronic clocked energy converter is proactively controlled by means of the control device.

13. The method as claimed in claim 12, wherein the proactive control comprises a transmission of a suitable control signal to the electronic clocked energy converter before a clock pulse sequence and/or a pulse pattern is activated by means of the control device.

14. (canceled)
